(19) United States
(12) Patent Application Publication
(10) Pub. No.: US 2014/0375620 A1
(43) Pub. Date: Dec. 25, 2014

(54) DISPLAY APPARATUS AND SOURCE DRIVER THEREOF

(71) Applicant: Novatek Microelectronics Corp., Hsinchu (TW)

(72) Inventors: Cheng-Hung Chen, Hsinchu County (TW); Jen-Chieh Hu, Kaohsiung City (TW); Ju-Lin Huang, Hsinchu County (TW); Yi-Chuan Liu, Hsinchu County (TW); Jhih-Siou Cheng, New Taipei City (TW)

(73) Assignee: Novatek Microelectronics Corp., Hsinchu (TW)

(21) Appl. No.: 14/054,853

(22) Filed: Oct. 16, 2013

(30) Foreign Application Priority Data
Jun. 20, 2013 (TW) 102121995

(51) Int. Cl. G09G 3/36

(52) U.S. Cl. CPC G09G 3/3696
USPC 345/212; 327/108; 345/211; 345/87

(57) ABSTRACT

A display apparatus and a source driver thereof are disclosed. The source driver includes a temperature sensor and a power switch. The temperature sensor is configured to measure a first working temperature of the source driver, and generate an over-temperature protection enable signal by comparing the first working temperature with a preset temperature. The power switch is coupled to a power transmission path for a core circuit of the source driver to receive an operating power, and configured to turn on or cut off the power transmission path according to the over-temperature protection enable signal.

### CROSS-REFERENCE TO RELATED APPLICATION

This application claims the priority benefits of Taiwan application serial no. 102121995, filed on Jun. 20, 2013. The entirety of the above-mentioned patent application is hereby incorporated by reference herein and made a part of this specification.

### BACKGROUND OF THE INVENTION

1. Field of the Invention

The invention relates to a display apparatus and a source driver thereof, and more particularly, to a source driver having a temperature sensing ability and a display apparatus using the same.

2. Description of Related Art

In a liquid crystal display (LCD) of conventional art which usually requires many source drivers (SD) and gate drivers in order to correspondingly generate a driving signal for receiving a pixel data and outputting a driving voltage to drive a display panel. However, in case of working for a long period of time, since the source driver constantly provides the driving voltage with positive polarity and negative polarity which are alternately switched, to the display panel during the outputting, such that the source drivers can generate heat to raise a working temperate thereof.

Based on above condition, if the source drivers of the LCD cannot monitor their own working temperatures for stating a protection function accordingly, the working temperature of the LCD may constantly raise to cause burn out to the drivers themselves, housing members of the display or other parts array. Accordingly, it is a subject worth researching how to make the display to include a source driver with an over-temperature protection function.

### SUMMARY OF THE INVENTION

The invention is directed to a source driver capable of detecting a working temperature of the source driver, and determining whether the working temperature is greater than a preset temperature, so that an operating method of the source driver can be changed accordingly to reduce the working temperature.

The invention is directed to a display apparatus capable of detecting whether a working temperature of the source driver is greater than a preset temperature, and an operating method is changed accordingly to reduce the working temperature.

The invention provides a source driver including a temperature sensor and a power switch. The temperature sensor is configured to measure a first working temperature of the source driver, and generate an over-temperature protection enable signal by comparing the first working temperature with a first preset temperature. The power switch is coupled to a power transmission path for a core circuit of the source driver to receive an operating power, and configured to turn on or cut off the power transmission path according to the over-temperature protection enable signal.

The invention provides a display apparatus including a display panel and a plurality of source drivers. The source drivers are coupled to the display panel, in which each of the source drivers generates at least one driving voltage to drive the display panel, and the source drivers respectively generates one or more over-temperature protection enable signals by comparing a plurality of working temperatures of the source drivers with a first preset temperature. The power switch is coupled to the source driver and configured to receive an over-temperature protection enable signal, and generate the over-temperature protection enable signal according to one or more over-temperature protection enable signals.

In an embodiment of the invention, if the first working temperature is greater than the first preset temperature, the temperature sensor cuts off the power transmission path according to the over-temperature protection enable signal.

In an embodiment of the invention, when the power transmission path is cut off and the first working temperature is reduced to less than a second preset temperature, the temperature sensor turns on the power transmission path according to the over-temperature protection enable signal, wherein the first preset temperature is greater than the second preset temperature.

In an embodiment provided by the invention, the core circuit includes at least one driving voltage generation circuit configured to receive the operating power through the power switch, and generate a driving voltage according to the pixel data.

In another embodiment of the invention, the display apparatus includes a power generator configured to generate an operating power for the display apparatus, in which the power generator stops generating the operating power or controls a voltage value of the operating power, according to the over-temperature protection enable signal.

In yet another embodiment of the invention, the display apparatus further includes a pixel data generator coupled to the source drivers, and configured to provide an identical pixel data to the source drivers according to the over-temperature protection enable signal.

In yet another embodiment of the invention, the pixel data generator is further configured to reduce a frame rate of the source drivers according to the over-temperature protection enable signal.

In yet another embodiment of the invention, the display apparatus further includes a plurality of output switches coupled to a plurality of driving voltage output paths of the driving voltage generation circuits, and configured to cut off the driving voltage output paths according to the over-temperature protection enable signal.

Based on above, the source driver of the invention is disposed with the temperature sensor to effectively detect the working temperature in an area where the source driver is located, so as to prevent risks of burn out to entire display apparatus and other parts array due to the working temperature of the source driver being overly high.

To make the above features and advantages of the disclosure more comprehensible, several embodiments accompanied with drawings are described in detail as follows.

### BRIEF DESCRIPTION OF THE DRAWINGS

FIG. 1 is an internal schematic diagram illustrating a source driver of a first embodiment of the invention.

FIG. 2 is a block circuit diagram illustrating a display apparatus of a second embodiment of the invention.

FIG. 3 is a block circuit diagram illustrating a third embodiment of the invention.

FIG. 4A is a block circuit diagram illustrating a fourth embodiment of the invention.

FIG. 4B is an operating timing diagram illustrating the fourth embodiment of the invention.

FIG. 5 is a block circuit diagram illustrating a fifth embodiment of the invention.

### DESCRIPTION OF THE EMBODIMENTS

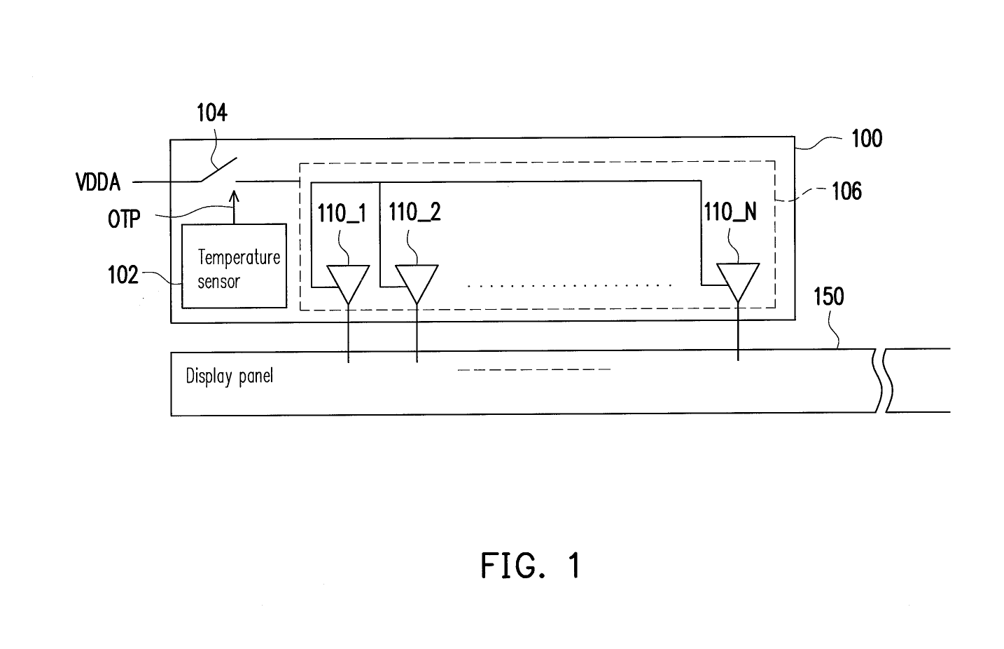

FIG. 1 is a schematic diagram illustrating a source driver 100 of a first embodiment of the invention. Referring to FIG. 1, the source driver 100 includes a temperature sensor 102, a power switch 104 and a core circuit 106, and the core circuit includes driving voltage generation circuits 110_1 to 110_N for driving the display panel 150. The power switch 104 is coupled to a transmission path for the core circuit 106 to receive an operating power VDDA.

In the present embodiment, the temperature sensor 102 detects the working temperature of the source driver 100, so as to obtain the working temperature. The temperature sensor 102 then compares the working temperature with a first preset temperature, and generates an over-temperature protection enable signal OTP according to a result of the comparison. In brief, when the temperature sensor 102 determines that the working temperature is greater than the first preset temperature, it indicates that an overheating has occurred on the source driver 100. Therefore, the temperature sensor 102 correspondingly generates the over-temperature protection enable signal OTP to cut off the power switch 104. Accordingly, the transmission path for the core circuit 106 to receive the operating power VDDA is cut off, so that the core circuit 106 is stopped.

It should be note that, after the core circuit 106 of the source driver 100 has been stopped for a period of time, the working temperature of the source driver 100 can be effectively reduced. In this case, when the temperature sensor 102 determines that the working temperature is reduced to less than a second preset temperature, the over-temperature protection enable signal OTP is correspondingly generated to turn on the power switch 104. In other words, when the working temperature of the source driver 100 is less than the second preset temperature, the transmission path for the core circuit 106 to receive the operating power VDDA is turned on again to resume normal operation. Therein, the first and the second preset temperatures can both be predetermined by a designer, and the first preset temperature is less than the second preset temperature.

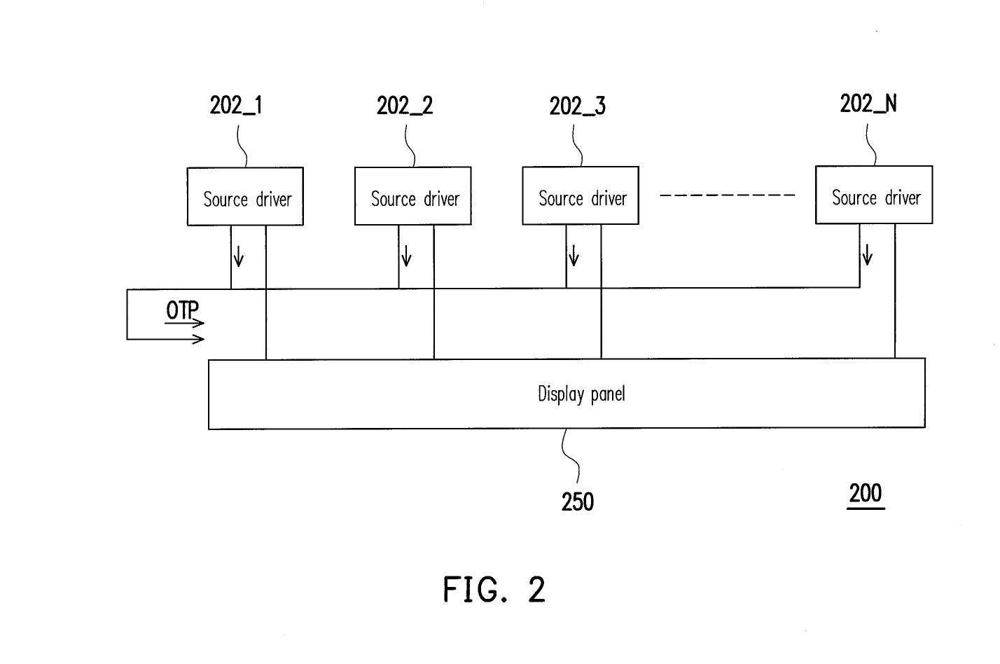

Referring to FIG. 2, FIG. 2 is a block circuit diagram illustrating a display apparatus of a second embodiment of the invention. A display apparatus 200 include a display panel 250 and N source drivers 202_1 to 202_N. The source drivers 202_1 to 202_N are coupled to the display panel 250.

In the present embodiment, each of the source drivers 202_1 to 202_N in the display apparatus 200 is arranged at a side of the display panel 250, for instance, extending from an upper left of the display panel 250 to an upper right of the display panel 250 as shown in the drawing. In this case, since each of the source drivers 202_1 to 202_N includes the temperature sensor, thus each of the source drivers 202_1 to 202_N can simultaneously detects the working temperature in an area where each of the source drivers 202_1 to 202_N is located in the display apparatus 200. When one or more source drivers among the source drivers 202_1 to 202_N detected that the working temperature is greater than the first preset temperature, the source driver being overheating then generates the over-temperature protection enable signal OTP to inform the display apparatus 200 that the working temperature in the area where said one or more source drivers are located is overheating. Accordingly, the corresponding over-temperature protection enable signal OTP can be outputted according to the received over-temperature protection enable signals 208_1 to 208_N, so that a cooling operation may be performed to the display apparatus 200.

However, there are various methods capable of cooling the display apparatus 200, a plurality of embodiments are provided below to further described cooling methods suitable for the display apparatus 200 when the overheating occurs.

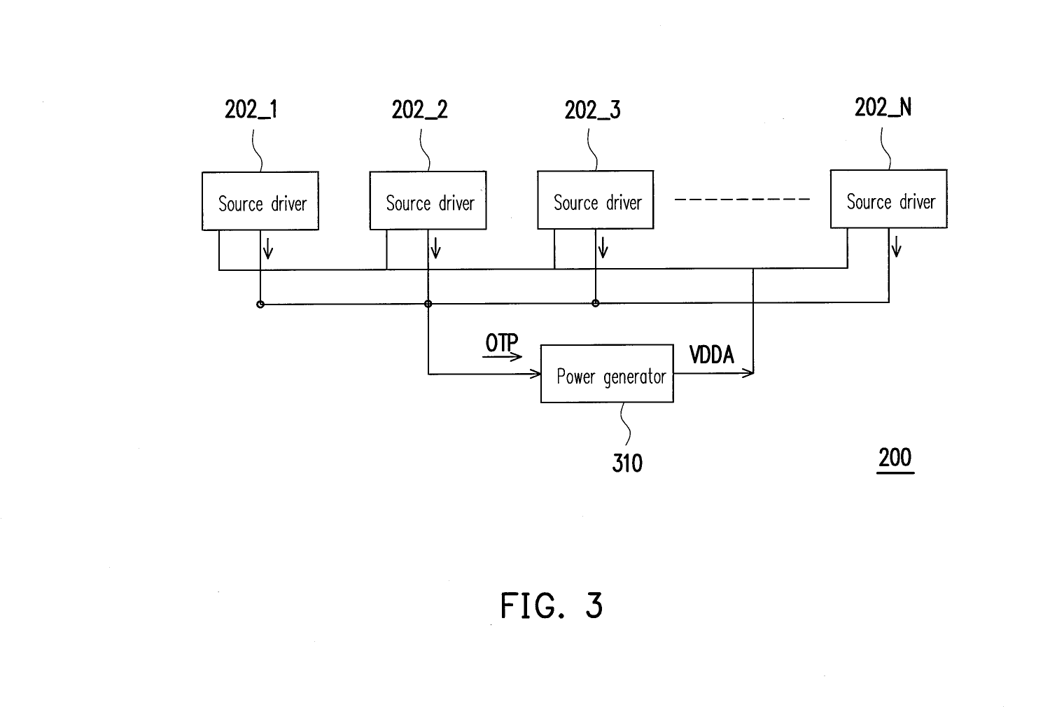

Referring to FIG. 3, FIG. 3 is a block circuit diagram illustrating a third embodiment of the invention. The source drivers 202_1 to 202_N are coupled to an input terminal of a power generator 310, and an output terminal of the power generator 300 is coupled to each of the source drivers 202_1 to 202_N.

The power generator 300 is configured to output the operating power VDDA for operating each of the source drivers 202_1 to 202_N, and to stop outputting the operating power VDDA for stop operating the source drivers 202_1 to 202_N, so to reduce the working temperature.

More specifically, when the power generator 310 is informed that the display apparatus 200 is overheating according to the received over-temperature protection enable signal, the power generator 310 turns off generating of the operating power VDDA according to the over-temperature protection enable signal OTP. Accordingly, each of the source drivers 202_1 to 202_N stops operating correspondingly, so that the working temperature of each of the source drivers 202_1 to 202_N may be reduced thereby. However, when the working temperature of each of the source drivers 202_1 to 202_N is reduced to less than the second preset temperature, the power generator 300 resumes to generate the operating power VDDA, so that each of the source drivers 202_1 to 202_N may resume normal operation.

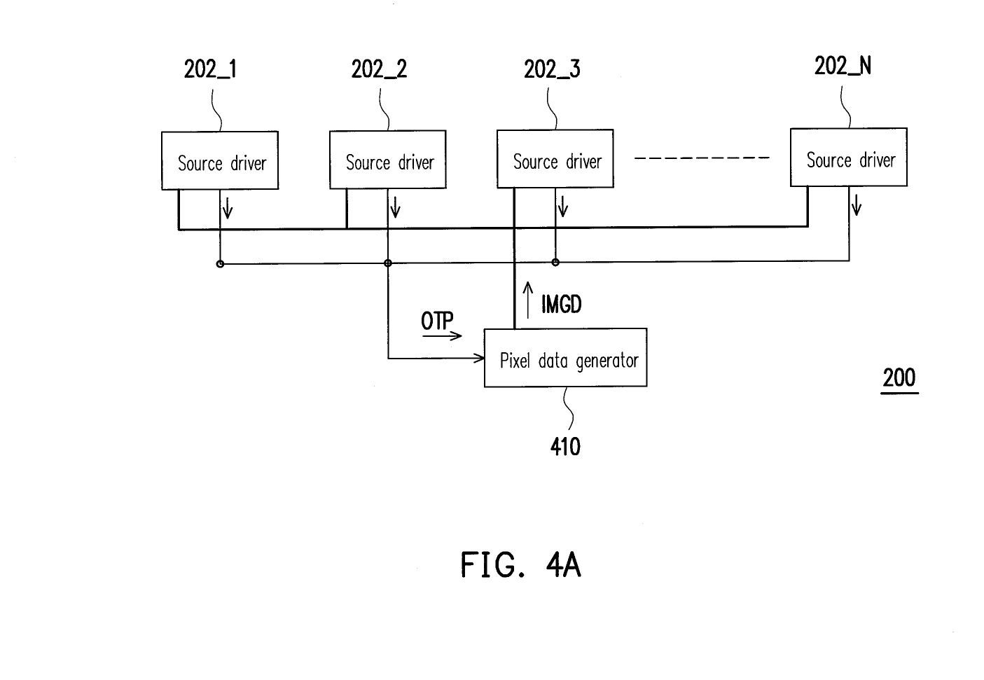

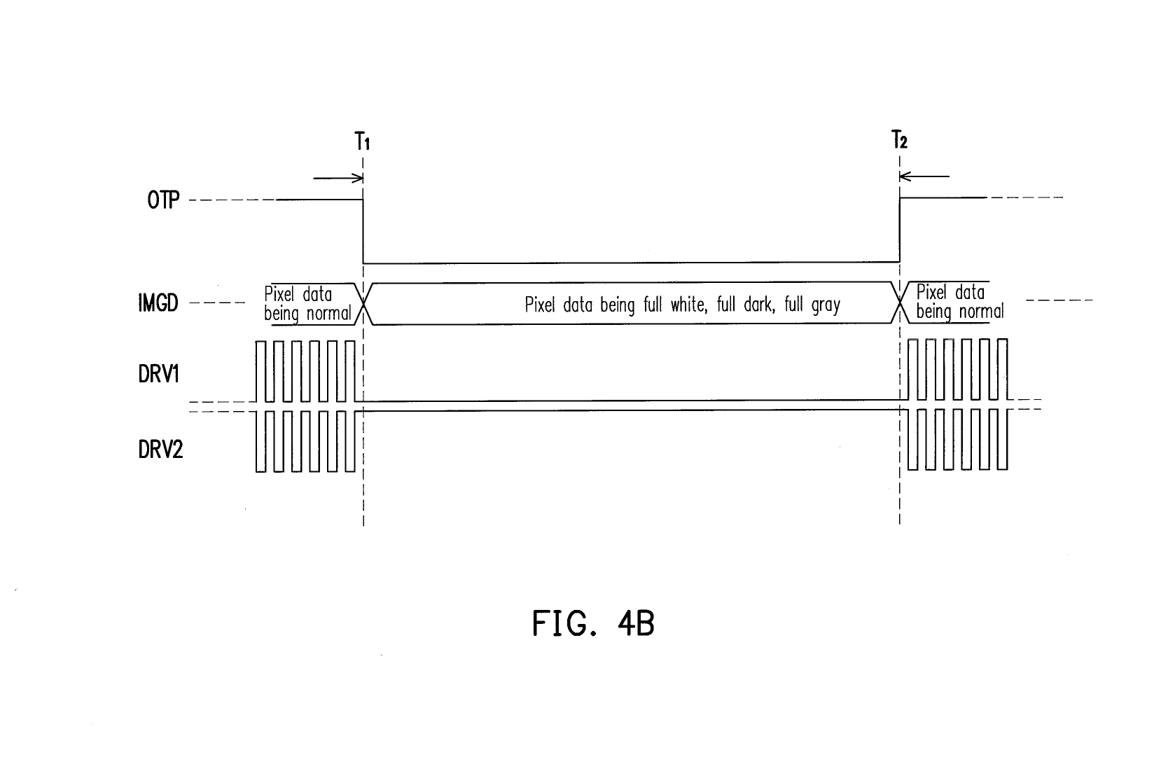

FIG. 4A is a block circuit diagram illustrating a fourth embodiment of the invention. Referring to FIG. 4A, in which the source drivers 202_1 to 202_N are coupled to an input terminal of a pixel data generator 410, and an output terminal of the pixel data generator 410 is coupled to each of the source drivers 202_1 to 202_N.

The pixel data generator 410 is configured to output a pixel data IMGD for the source drivers 202_1 to 202_N to output a driving voltage to the display apparatus 200. Herein, a power consumption required by the source drivers 202_1 to 202_N can be reduced by the pixel data IMGD specially output by the the pixel data generator 410. For instance, when the working temperature of at least one among the source drivers 202_1 to 202_N in the display apparatus is overly high, the pixel data generator 410 can output the pixel data IMGD being, for example, frames that displayed in full white, full dark or full gray, so as to be used for reducing a total power consumption that the source drivers 202_1 to 202_N may consume. Referring to FIG. 4B together, which is an operating timing diagram illustrating the fourth embodiment of the invention. Therein, at a time point T1, the pixel data generator 410 receives the over-temperature protection enable signal OTP, which means that the received over-temperature protection enable signal OTP is changed from a logic high level to a logic low level, so that when the display apparatus 200 is overheating, the pixel data IMGD may be switched from a pixel data being normal to a pixel data with an identical gray level (e.g, full white, full dark or full gray), accordingly. Therefore, driving voltages DRV1 and DRV2 generated by the source drivers 202_1 to 202_N can stop oscillating, and maintain at a fixed voltage level. Accordingly, the power consumption required by the source drivers 202_1 to 202_N can be effectively reduced, so that the working temperature of the display apparatus 200 may also be effectively reduced.

In addition, the driving voltages DRV1 and DRV2 are used to provide voltage with different polarities for driving the display panel.

Furthermore, in a time point T2, when the working temperature of the source drivers 202_1 to 202_N is reduced to less than the second preset temperature, after over-temperature protection enable signal OTP received by the pixel data generator 410 is switched from the logic low level to the logic high level, the pixel data IMGD being the normal pixel data may resume to be provided. Accordingly, the display apparatus 200 may resume normal operation.

Certainly, as described in the foregoing embodiments, a method that indicates the display apparatus 200 is overheating when the over-temperature protection enable signal OTP is equal to the logic high level, and indicates the display apparatus 200 is not overheating when the over-temperature protection enable signal OTP is equal to the logic low level, is merely an illustrative example, the designer may customize settings regarding the meaning for logic level of the over-temperature protection enable signal OTP.

On the other hand, the pixel data generator 410 of the present embodiment may further reduce the power consumption required by the display apparatus 200 by reducing a frame rate of the pixel data IMGD output by the source drivers 202_1 to 20_N according to the over-temperature protection enable signal OTP.

More specifically, the pixel data generator 410 is configured to output the pixel data IMGD for the source drivers 202_1 to 202_N to output the driving voltage to the display apparatus 200. Herein, the pixel data generator 410 can control the source drivers 202_1 to 202_N to reduce the power consumption required by the display apparatus 200 by reducing the frame rate of the output pixel data IMGD. For instance, when the working temperature of at least one among the source drivers 202_1 to 202_N in the display apparatus 200 is overly high, the pixel data generator 410 can reduce the frame rate of the pixel data IMGD of the source drivers 202_1 to 202_N, so as to be used for reducing the total power consumption that the source drivers 202_1 to 202_N may consume.

Similarly, when the working temperature of the source drivers 202_1 to 202_N is reduced to less than the second preset temperature, the pixel data IMGD being the normal pixel data may resume to be provided. Accordingly, the display apparatus 200 may resume normal operation.

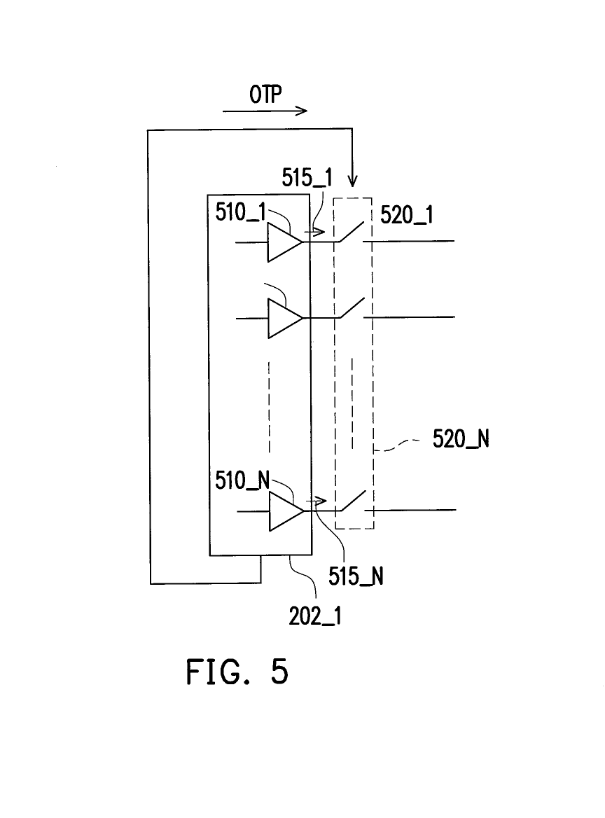

FIG. 5 is a block circuit diagram illustrating a fifth embodiment of the invention. Since an operating method for each of the source drivers 202_1 to 202_N is identical, for the clarity and simplicity, only the source driver 202_1 is illustrated herein as a representative for the source drivers 202_1 to 202_N, but the invention is not limited thereto. The source driver 202_1 includes a plurality of driving voltage generation circuits 510_1 to 510_N. Output switches 520_1 to 520_N are located on transmission paths for correspondingly receiving driving voltages 515_1 to 515_N output by the driving voltage generation circuits 510_1 to 510_N. The output switches 520_1 to 520_N can be elements that is capable of switching circuit actions according to an external control signal, such as a change-over switch, a diode switch or a transistor switch, but the invention is not limited thereto.

In the present embodiment, when the source driver 202_1 is overheating, the source driver 202_1 outputs the over-temperature protection enable signal OTP to the output switches 510_1 to 510_N. As a result, the output switches 510_1 to 510_N cut off the transmission paths for the the source driver 202_1 to output the driving voltages 515_1 to 515_N according to the over-temperature protection enable signal OTP, so that the source driver 202_1 can stop driving, so as to reduce the working temperature of the source driver 202_1. However, when the working temperature of the source driver 202_1 is reduced to less than the second preset temperature, the transmission paths for the source driver 202_1 to output the driving voltages 515_1 to 515_N is turned on again, so that the display apparatus 200 may resume normal operation.

In summary, in the display apparatus of the invention, each of the source drivers in the display apparatus is disposed with the temperature sensor for detecting whether the working temperature is greater than the preset temperature. Accordingly, the working temperature of the display apparatus may be controlled more completely, such that when the display apparatus is overheated, an effective over-temperature protection mechanism can be executed.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A source driver, comprising:
a temperature sensor configured to measure a first working temperature of the source driver, and generate an over-temperature protection enable signal by comparing the first working temperature with a preset temperature; and
a power switch coupled to a power transmission path for a core circuit of the source driver to receive an operating power, and the power switch being configured to turn on or cut off the power transmission path according to the over-temperature protection enable signal.

2. The source driver of claim 1, wherein if the first working temperature is greater than the first preset temperature, the temperature sensor cuts off the power transmission path according to the over-temperature protection enable signal.

3. The source driver of claim 2, wherein when the power transmission path is cut off and the first working temperature is reduced to less than a second preset temperature, the temperature sensor turns on the power transmission path according to the over-temperature protection enable signal, wherein the first preset temperature is greater than the second preset temperature.

4. The source driver of claim 3, wherein the core circuit comprises:
at least one driving voltage generation circuit configured to receive the operating power through the power switch, and generate a driving voltage according to a pixel data.

5. A display apparatus, comprising:
a display panel;
a plurality of source drivers coupled to the display panel, each of the source drivers generating at least one driving voltage to drive the display panel, and the source drivers respectively generating one or more over-temperature protection enable signals by comparing a plurality of working temperatures of the source drivers with a first preset temperature.

6. The display apparatus of claim 5, further comprising:
a power generator configured to generate an operating power for the display apparatus, wherein the power generator stops generating the operating power or controls a voltage value of the operating power, according to the over-temperature protection enable signal.

7. The display apparatus of claim 5, further comprising:
a pixel data generator coupled to the source drivers, and configured to provide an identical pixel data to the source drivers according to the over-temperature protection enable signal.

8. The display apparatus of claim 7, wherein the pixel data generator is further configured to reduce a frame rate of the source drivers according to the over-temperature protection enable signal.

9. The display apparatus of claim 5, wherein each of the source drivers comprises:
a temperature sensor configured to measure the first working temperature of the source driver, and generate the over-temperature protection enable signal by comparing the first working temperature with the preset temperature; and
a power switch coupled to a power transmission path for a core circuit of the source driver to receive an operating power, and configured to turn on or cut off the power transmission path according to the over-temperature protection enable signal.

10. The display apparatus of claim 9, wherein if the first working temperature is greater than the first preset temperature, the temperature sensor cuts off the power transmission path according to the over-temperature protection enable signal.

11. The display apparatus of claim 9, wherein the core circuit comprising:
at least one driving voltage generation circuit configured to receive the operating power through the power switch, and generate a driving voltage according to the pixel data.

12. The display apparatus of claim 5, further comprising:
a plurality of output switches coupled to a plurality of driving voltage output paths of the driving voltage generation circuits, and configured to cut off the driving voltage output paths according to the over-temperature protection enable signal.
